(19) United States
(12) Patent Application Publication
(10) Pub. No.: US 2015/0172408 A1
(43) Pub. Date: Jun. 18, 2015

(54) Unified service platform for ubiquitous network and service implementation method

(71) Applicant: ZTE Corporation, Shenzhen, Guangdong (CN)

(72) Inventor: Aifang Sun, Shenzhen (CN)

(73) Assignee: ZTE Corporation, Shenzhen, Guangdong (CN)

(21) Appl. No.: 14/414,544

(22) PCT Filed: Jun. 26, 2013
(86) PCT No.: PCT/CN2013/078076

§ 371 Date: Jan. 13, 2015

(30) Foreign Application Priority Data
Jul. 27, 2012 (CN) 201210264065.8

(51) Int. Cl. H04L 29/08

(52) U.S. Cl. CPC H04L 67/2838

(57) ABSTRACT

A unified service platform for a ubiquitous network is provided, which at least includes a database server configured to store various data resource information of each heterogeneous network and support the data sharing and unified management of each heterogeneous network; a context server configured to store the abstract ability information of each layer, perform context management, collect context information, and perform abstraction and classification; an application server, configured to provide service generation information, discover and select at least one service component by virtue of the service context information acquired from the context server, generate a service component and provide the service component for an application management server; and the application management server, configured to manage service deployment according to the service component, execute a service and control an execution cycle of the service. A service implementation method based on a unified service platform for a ubiquitous network is also provided. According to the disclosure, rich intelligent and personalized services can be provided for users according to service contents, user preferences, terminal capabilities and network characteristics.

### TECHNICAL FIELD

The disclosure relates to the field of ubiquitous network communications, in particular to a unified service platform for a ubiquitous network, and a service implementation method.

### BACKGROUND

In an Internet of things environment, a local area network or a cognitive network transmits a service through a communication network by virtue of unified access equipment, thereby providing the service for a user. However, in a ubiquitous collaboration network environment, a variety of heterogeneous networks coexist for a long time and form different network forms in different organization manners, which makes the terminal heterogeneity and network heterogeneity problem more complicated; a user may require one or more local networks or cognitive networks to directly provide information data, or require multiple pieces of heterogeneous network equipment in one cognitive network to directly provide a service; different users select services according to different requirements of their own, and how to dynamically adapt all acquired service information to different users to meet the requirements of the users and how to achieve the effective compatibility of various ubiquitous network-oriented application service with multiple heterogeneous networks have gradually become key problems to be solved for the provision of services for users in the ubiquitous network environment.

### SUMMARY

In view of this, a main purpose of the disclosure is to provide a unified service platform for a ubiquitous network and a service implementation method thereof, which can provide rich intelligent and personalized services for users according to service contents, user preferences, terminal capabilities and network characteristics.

In order to achieve the purpose, the technical solutions of the disclosure are implemented as follows.

A unified service platform for a ubiquitous network is provided, the unified service platform at least including a database server, a context server, an application server and an application management server, wherein
the database server is configured to store various data resource information of each heterogeneous network, and support the data sharing and unified management of each heterogeneous network;
the context server is configured to store the abstract ability information of each layer, perform context management, collect context information, and perform abstraction and classification;
the application server is configured to provide service generation information, discover and select at least one service component by virtue of the service context information acquired from the context server, generate a service component and provide the service component for the application management server; and
the application management server is configured to manage service deployment according to the service component, execute a service and control an execution cycle of the service.

In one embodiment, the context server is further configured to acquire the context information of each level by virtue of a cognition technology, and share the context information with the database server, the application server and the application management server.

In one embodiment, the application server is further configured to perform dynamic intelligent service discovery, selection, aggregation and adaptation according to the context information shared by the context server, monitor and collect a state of a ubiquitous and heterogeneous network environment and a state of a terminal environment in a unified manner, track and feed back a change in a user service environment in real time, and perform service negotiation and adaptation processing.

In one embodiment, the application management server is further configured to parse a service deployment configuration file, split the service deployment configuration file into service deployment configuration sub-files, package the service deployment configuration sub-files with corresponding shared data and drivers, and transmit the packages to corresponding terminals for deployment and execution.

In one embodiment, the context information includes a service context, a user context, a network context and a terminal context, wherein
the service context includes at least one piece of the following information: a service type and a combination type of services;
the user context includes at least one piece of the following information: a network environment where a user is located and a physical state of the user;
the network context includes at least one piece of the following information: a network description, an ordinary resource of the network and the context information of a data stream; and
the terminal context includes at least one piece of the following information: a terminal capability, a terminal service and a terminal network environment.

A service implementation method based on a unified service platform for a ubiquitous network is provided, wherein the unified service platform at least includes a database server, a context server, an application server and an application management server, and the method includes that:
the context server transmits more than one received service request to the application server, the application server processes the more than one service request, generates a service component, and transmits the service component to the application management server, and the application management server manages service deployment according to the service component, executes a service and controls an execution cycle of the service.

In one embodiment, the method further includes that the application management server parses a service deployment configuration file, splits the service deployment configuration file into service deployment configuration sub-files, packages the service deployment configuration sub-files with corresponding shared data and drivers, and transmit the packages to corresponding terminals for deployment and execution.

In one embodiment, the method further includes that the context server acquires the context information of each level by virtue of a cognition technology, and shares the context information to the database server, the application server and the application management server.

In one embodiment, the method further includes that the application server performs dynamic intelligent service discovery, selection, aggregation and adaptation according to the context information shared by the context server, monitors and collects a state of a ubiquitous and heterogeneous network environment and a state of a terminal environment in a unified manner, tracks and feeds back a change in a user service environment in real time, and performs service negotiation and adaptation processing.

In one embodiment, context information includes a service context, a user context, a network context and a terminal context, wherein
the service context includes at least one piece of the following information: a service type and a combination type of services;
the user context includes at least one piece of the following information: a network environment where a user is located and a physical state of the user;
the network context includes at least one piece of the following information: a network description, an ordinary resource of the network and the context information of a data stream; and
the terminal context includes at least one piece of the following information: a terminal capability, a terminal service and a terminal network environment.

The unified service platform of the disclosure at least includes a database server, a context server, an application server and an application management server, wherein the database server is configured to store various data resource information of each heterogeneous network, and support the data sharing and unified management of each heterogeneous network; the context server is configured to store the abstract ability information of each layer, perform context management, collect the context information and perform abstraction and classification; the application server is configured to provide the service generation information, discover and select at least one service component by virtue of the service context information acquired from the context server, generate a service component and provide the service component for the application management server; and the application management server is configured to take charge of management over the service deployment, execute the service and control the execution cycle of the service. The unified service platform of the disclosure supports data sharing among the servers, a user can operate multiple pieces of data under a ubiquitous network condition without concerning about details such as its data mode matching problem, data format conversion, and a physical location of a database, and all physical and logic differences of the data can be shaded. More importantly, completely transparent operation over any database resource can be implemented, and the unification of openness and universality of the ubiquitous network with a data sharing mechanism is achieved.

### BRIEF DESCRIPTION OF THE DRAWINGS

FIG. 1 is a structure diagram of a unified service platform for a ubiquitous network according to an embodiment of the disclosure; and

FIG. 2 is a flowchart of a service implementation method based on a unified service platform for a ubiquitous network according to an embodiment of the disclosure.

### DETAILED DESCRIPTION

In order to make the purpose, technical solutions and advantages of the disclosure clearer, the disclosure is further described below with reference to the embodiments and the drawings in detail.

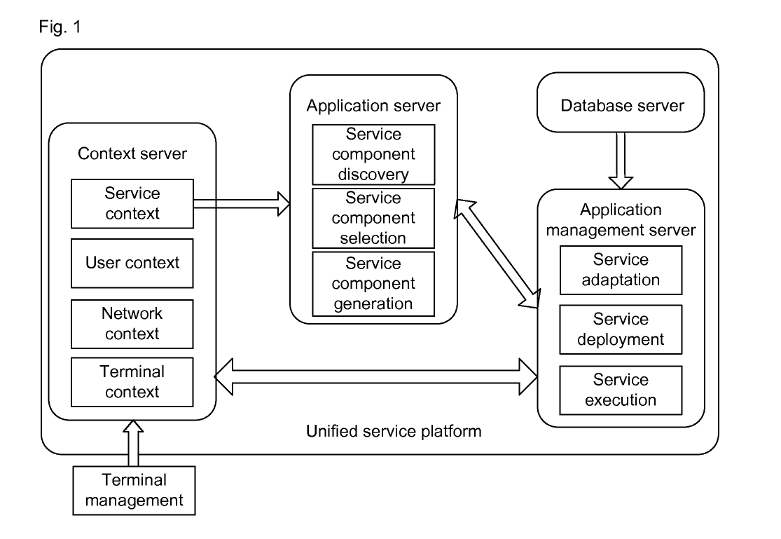

FIG. 1 is a structure diagram of a unified service platform for a ubiquitous network according to an embodiment of the disclosure, and as shown in FIG. 1, the unified service platform for a service application in a ubiquitous network environment includes a database server, a context server, an application server, an application management server and a terminal management server.

The database server here, as a data centre of the unified service platform, stores various data resources, and also performs sharing and unified management on the data of each heterogeneous network.

The context server here stores an abstract ability of each level based on a cross-layer cognition technology, and provides the abstract abilities for the unified service platform for query to generate a specific service. The core of the context server is a context service engine, which provides a context management function, collects context information and performs abstraction, classification and the like.

The context includes a service context, a user context, a network context and a terminal context; wherein
the service context includes, but not limited to, a service type, a combination type of services, and the like;
the user context includes a network environment (a user location, available equipment, an available network and the like) where a user is located, and a physical state (for example, identity, a personal preference and a use record) of the user;
the network context includes a network description (for example, a network identifier, a location, an access type, a coverage and an Internet Protocol (IP) address), an ordinary resource (for example, a bandwidth, a supported service, an available media interface, available service quality and a security level) of the network, and the context information of a data stream; and
the terminal context includes a terminal capability, a terminal service, a terminal network environment and the like, wherein the terminal capability includes, but not limited to, a display screen, a supported service set, a user identifier and a graphic form; the terminal service includes, but not limited to, a combination mode of terminals to be used by a user, a terminal activation condition, priority of terminals to be used by a user and the like; and the terminal network environment includes, but not limited to, a terminal type, a manufacturer, a vendor and the like.

The application server comprehensively manages service components, and provides service generation information. The application server discovers and selects service components by virtue of the service context information of the context service engine, and generates a specific service component to provide for the application management server. In addition, the application server also provides a terminal management function, and aggregates the resource description information of the terminal.

Furthermore, functions supported by the application server mainly include service component discovery, service component selection and service component generation; wherein
the service component discovery refers to the discovery of components forming the service;
the service component selection refers to the effective selection of service components according to user requirements; and
the service component generation refers to the generation of service components required by a user from the service components selected according to the user requirements.

The application management server takes charge of management over the service deployment, executes a service and control the execution cycle of the service. A service deployment configuration file is parsed and split into service deployment configuration sub-files, the service deployment configuration sub-files are packaged with corresponding shared libraries and drivers, and then transmitted to corresponding terminals for deployment and execution.

Main services of the application management server include service adaptation, service deployment and service execution; wherein
the service adaptation refers to the adaptation of service components according to user requirements, such as the adaptation of a proper context service engine according to service requests of the users; and
the service deployment refers to that a certain service component should be deployed at which specific terminal, and which shared library and driver information are required, as described by the service deployment configuration file. A process of the service deployment should include the generation of a service deployment configuration file, the splitting of the service deployment configuration file into service deployment configuration sub-files, deployment configuration at each corresponding terminal, and the completion of downloading of related service components for service execution.

The terminal management refers to unified management over multiple heterogeneous network terminals in the whole ubiquitous network environment, so as to deploy corresponding terminals for service downloading or acquire service data information by virtue of terminals.

How to implement a unified service by the coordinate work of each server in the unified service platform of the disclosure is further described below by a specific example.

It is supposed that a user A wants to monitor a situation in the home, including security and a home environment, for example, the user A wants to check temperature and humidity in the home before returning home from work to determine when to remotely start an air conditioner and the like; and it is supposed that a user B is a personal healthcare worker for an old person in the home, and the user B periodically checks a physical condition of the old person and a home environment condition every day to analyze a health problem of the old person.

After the users A and B transmit service requests, a sensor network for sensing the security and environment and a body area network for detecting various body parameters of the old person timely acquire data, and transmit node information data to the unified service platform of the disclosure (the unified service platform is between the network and an application layer) through a communication network by virtue of terminal equipment such as a gateway of a local area network or a coordinator, and the unified service platform searches for context information in a unified manner, manages terminals in the ubiquitous network in the unified manner, and also shares and manages the data by virtue of the database server; and the unified service platform dynamically adapts services by virtue of the application management server, finally forms an adapted service 1 and an adapted service 2, which are required by the users, and provides the adapted service 1 and the adapted service 2 for the user A and the user B respectively.

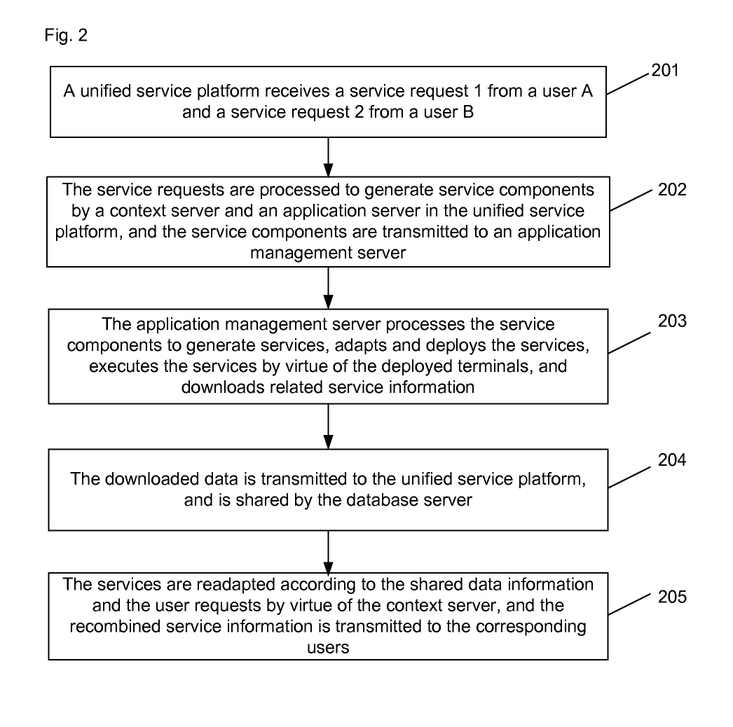

FIG. 2 is a flowchart of a service implementation method based on a unified service platform for a ubiquitous network according to an embodiment of the disclosure, and as shown in FIG. 2, the service implementation method based on the unified service platform for the ubiquitous network includes the following steps that:

Step 201: the unified service platform receives a service request 1 from a user A and a service request 2 from a user B.

In a typical application scenario of a ubiquitous network, the user A wants to monitor a situation in the home, and meanwhile, the user B monitors an old person in the home as a personal healthcare worker. The user A sends a service request of monitoring the situation in the home; the content of the service request includes security and a home environment, for example, the user A wants to check temperature, humidity and the like in the home before returning home from work; meanwhile, the personal healthcare worker for the old person in the home, i.e. the user B, needs to monitor a condition of the old person, including a physical condition of the old person and an environment where the old person is located, so as to more comprehensively analyze the physical condition of the old person and find a cause for an appearing problem; and the users A and B simultaneously transmit the service request 1 and the service request 2, wherein the service request 1 and the service request 2 are transmitted to the unified service platform through a unified interface.

Step 202 includes that the service requests are processed to generate service components by a context server and an application server in the unified service platform, and the service components are transmitted to an application management server.

A service context engine in the context server in the unified service platform performs service component discovery according to the service components in the application server, services required by the users are selected by the service components, and finally, the services requested by the service requests and required by the users are generated by virtue of the service components, and are simultaneously transmitted to the application management server.

Step 203 includes that the application management server processes the service components to generate services, adapts and deploys the services, processes the services by virtue of the deployed terminals, and downloads related service information.

The application management server forms service configuration sub-files by virtue of service deployment, and allocates the service configuration sub-files to different terminals such as gateways for the downloading of corresponding services, such as the information acquisition of a camera, a security door, temperature and humidity sensors, and a sensor at the old person; and an instruction is transmitted by service execution to ask the terminals to start downloading the services.

Step 204 includes that the downloaded data is transmitted to the unified service platform, and is shared through the database server.

After receiving service request information, the gateway in a home area, the coordinator at the old person and the like transmit the data information, which is acquired in real time (such as the real-time data of the camera, the security door, the temperature and humidity sensors and the sensor at the old person), to the unified service platform through different networks respectively. The unified service platform stores the data into the database server for data sharing through the unified interface.

Step 205 includes that the services are readapted according to the shared data information and the user requests by virtue of the context server, and the recombined service information is transmitted to the corresponding users.

The unified service platform performs service re-adaptation according to the received service data information by virtue of a service adaptation function of the application management server. The services are classified and recombined into services required by the users according to the service requests of the users and the service context engine, and the services required by the users are transmitted to the users through the unified interface.

In the disclosure, service application information is shown in table 1 as follows:

TABLE 1

| Service context | Monitoring | Environment sens- | Body area net- |
|---|---|---|---|
| engine | equipment | ing equipment | work equipment |
| Data | Camera | Temperature sensor | Blood pressure |
| acquisition | | | sensor |
| terminal | Security door | Humidity sensor | Pulse sensor |
| | . . . | . . . | . . . |
| User | User A | Users A and B | User B |

| | |
|---|---|
| Service | Service application 1 (correspond- |
| adaptation | ing to the service request 1) |

| | |
|---|---|
| Service | Service application 2 (correspond- |
| adaptation | ing to the service request 2) |

According to the disclosure, by the implementation method for a service application in the ubiquitous network environment, the data of various heterogeneous networks in the unified service platform is transparently managed, and information is exchanged with the application layer and a network layer through the unified service interface, so that not only service requirements of different users can be dynamically and adaptively met in the ubiquitous network environment where various heterogeneous networks coexist, various heterogeneous networks and network equipment are shielded, but also the whole network, services, and terminal context information of the ubiquitous network can be managed and scheduled in the unified manner to simplify the provision of the services and achieve high operability; and moreover, advantages can be took to make up deficiency, and the data of the networks is shared to meet diversified requirements of the users and avoid the condition that a single network just meets a single requirement of the users.

The above are only embodiments of the disclosure and not intended to limit the scope of protection of the disclosure.

### INDUSTRIAL APPLICABILITY

According to the disclosure, the unified service platform supports data sharing among servers, a user can operate multiple pieces of data under the ubiquitous network condition without concerning about the details such as its data mode matching, data format conversion and the physical location of the database, and all the physical and logic differences of the data can be shaded. More importantly, completely transparent operation over any database resource can be implemented, and the unification of openness and universality of the ubiquitous network with the data sharing mechanism is emphasized.

What is claimed is:

1. A unified service platform for a ubiquitous network, at least comprising a database server, a context server, an application server and an application management server, wherein
the database server is configured to store various data resource information of each heterogeneous network, and support data sharing and unified management of each heterogeneous network;
the context server is configured to store abstract ability information of each layer, perform context management, collect context information, and perform abstraction and classification;
the application server is configured to provide service generation information, discover and select at least one service component by virtue of service context information acquired from the context server, generate a service component and provide the service component for the application management server; and
the application management server is configured to manage service deployment according to the service component, execute a service and control an execution cycle of the service.

2. The unified service platform according to claim 1, wherein the context server is further configured to acquire context information of each level by virtue of a cognition technology, and share the context information with the database server, the application server and the application management server.

3. The unified service platform according to claim 1, wherein the application server is further configured to perform dynamic intelligent service discovery, selection, aggregation and adaptation according to the context information shared by the context server, monitor and collect a state of a ubiquitous and heterogeneous network environment and a state of a terminal environment in a unified manner, track and feed back a change in a user service environment in real time, and perform service negotiation and adaptation processing.

4. The unified service platform according to claim 1, wherein the application management server is further configured to parse a service deployment configuration file, split the service deployment configuration file into service deployment configuration sub-files, package the service deployment configuration sub-files with corresponding shared data and drivers, and transmit the packages to corresponding terminals for deployment and execution.

5. The unified service platform according to claim 1, wherein the context information comprises a service context, a user context, a network context and a terminal context, wherein
the service context comprises at least one piece of following information: a service type, and a combination type of services;
the user context comprises at least one piece of following information: a network environment where a user is located, and a physical state of the user;
the network context comprises at least one piece of following information: a network description, an ordinary resource of the network and context information of a data stream; and
the terminal context comprises at least one piece of following information: a terminal capability, a terminal service and a terminal network environment.

6. A service implementation method based on a unified service platform for a ubiquitous network, wherein the unified service platform at least comprises a database server, a context server, an application server and an application management server, the method comprising:
transmitting, by the context server, more than one service request received to the application server;
processing, by the application server, the more than one service request, generating a service component, and transmitting the service component to the application management server; and
managing, by the application management server, service deployment according to the service component, executing a service and controlling an execution cycle of the service.

7. The method according to claim 6, further comprising:
parsing, by the application management server, a service deployment configuration file, splitting the service deployment configuration file into service deployment configuration sub-files, packaging the service deployment configuration sub-files with corresponding shared data and drivers, and transmitting the packages to corresponding terminals for deployment and execution.

8. The method according to claim 6, further comprising:
acquiring, by the context server, context information of each level by virtue of a cognition technology, and sharing the context information with the database server, the application server and the application management server.

9. The method according to claim 6, further comprising:
performing, by the application server, dynamic intelligent service discovery, selection, aggregation and adaptation according to context information shared by the context server, monitoring and collecting a state of a ubiquitous and heterogeneous network environment and a state of a terminal environment in a unified manner, tracking and feeding back a change in a user service environment in real time, and performing service negotiation and adaptation processing.

10. The method according to claim 6, wherein the context information comprises a service context, a user context, a network context and a terminal context, wherein
the service context comprises at least one piece of following information: a service type and a combination type of services;
the user context comprises at least one piece of following information: a network environment where a user is located, and a physical state of the user;
the network context comprises at least one piece of following information: a network description, an ordinary resource of the network, and context information of a data stream; and
the terminal context comprises at least one piece of following information: a terminal capability, a terminal service and a terminal network environment.

11. The unified service platform according to claim 2, wherein the context information comprises a service context, a user context, a network context and a terminal context, wherein
the service context comprises at least one piece of following information: a service type, and a combination type of services;
the user context comprises at least one piece of following information: a network environment where a user is located, and a physical state of the user;
the network context comprises at least one piece of following information: a network description, an ordinary resource of the network and context information of a data stream; and
the terminal context comprises at least one piece of following information: a terminal capability, a terminal service and a terminal network environment.

12. The unified service platform according to claim 3, wherein the context information comprises a service context, a user context, a network context and a terminal context, wherein
the service context comprises at least one piece of following information: a service type, and a combination type of services;
the user context comprises at least one piece of following information: a network environment where a user is located, and a physical state of the user;
the network context comprises at least one piece of following information: a network description, an ordinary resource of the network and context information of a data stream; and
the terminal context comprises at least one piece of following information: a terminal capability, a terminal service and a terminal network environment.

13. The unified service platform according to claim 4, wherein the context information comprises a service context, a user context, a network context and a terminal context, wherein
the service context comprises at least one piece of following information: a service type, and a combination type of services;
the user context comprises at least one piece of following information: a network environment where a user is located, and a physical state of the user;
the network context comprises at least one piece of following information: a network description, an ordinary resource of the network and context information of a data stream; and
the terminal context comprises at least one piece of following information: a terminal capability, a terminal service and a terminal network environment.

14. The method according to claim 7, wherein the context information comprises a service context, a user context, a network context and a terminal context, wherein
the service context comprises at least one piece of following information: a service type and a combination type of services;
the user context comprises at least one piece of following information: a network environment where a user is located, and a physical state of the user;
the network context comprises at least one piece of following information: a network description, an ordinary resource of the network, and context information of a data stream; and
the terminal context comprises at least one piece of following information: a terminal capability, a terminal service and a terminal network environment.

15. The method according to claim 8, wherein the context information comprises a service context, a user context, a network context and a terminal context, wherein
the service context comprises at least one piece of following information: a service type and a combination type of services;
the user context comprises at least one piece of following information: a network environment where a user is located, and a physical state of the user;
the network context comprises at least one piece of following information: a network description, an ordinary resource of the network, and context information of a data stream; and
the terminal context comprises at least one piece of following information: a terminal capability, a terminal service and a terminal network environment.

16. The method according to claim 9, wherein the context information comprises a service context, a user context, a network context and a terminal context, wherein
the service context comprises at least one piece of following information: a service type and a combination type of services;
the user context comprises at least one piece of following information: a network environment where a user is located, and a physical state of the user;
the network context comprises at least one piece of following information: a network description, an ordinary resource of the network, and context information of a data stream; and
the terminal context comprises at least one piece of following information: a terminal capability, a terminal service and a terminal network environment.
